(19) United States
(12) Patent Application Publication
(10) Pub. No.: US 2024/0370049 A1
(43) Pub. Date: Nov. 7, 2024

(54) INPUT DEVICE

(71) Applicant: Panasonic Automotive Systems Co., Ltd., Kanagawa (JP)

(72) Inventors: Madoka IMURA, Tokyo (JP); Mizuki MATSUI, Fukui (JP)

(21) Appl. No.: 18/774,685

(22) Filed: Jul. 16, 2024

Related U.S. Application Data
(63) Continuation of application No. PCT/JP2022/043089, filed on Nov. 22, 2022.

(30) Foreign Application Priority Data
Jan. 21, 2022 (JP) 2022-007818

(51) Int. Cl. G05G 9/047

(52) U.S. Cl. CPC G05G 9/047; G05G 2009/04744

(57) ABSTRACT

An input device includes: an operation component that tilts in a first direction in response to a user operation; an expansion component that tilts in the first direction relative to the operation component, in conjunction with tilting of the operation component; a magnet supported by the expansion component; a sensor board that is disposed to face the magnet, and detects a tilting movement made by the operation component; a detent pin supported by the expansion component in a retractable manner; and an energizing component that energizes the detent pin toward a detent surface to press a tip of the detent pin against the detent surface. With respect to a tilt amount of the operation component, the expansion component increases a movement amount of the magnet and a movement amount of the tip of the detent pin in a direction parallel to the detent surface.

### CROSS REFERENCE TO RELATED APPLICATIONS

This is a continuation application of PCT International Application No. PCT/JP2022/043089 filed on Nov. 22, 2022, designating the United States of America, which is based on and claims priority of Japanese Patent Application No. 2022-007818 filed on Jan. 21, 2022. The entire disclosures of the above-identified applications, including the specifications, drawings and claims are incorporated herein by reference in their entirety.

### FIELD

The present disclosure relates to an input device that receives a user operation.

### BACKGROUND

A shifting device provided in vehicles is known as an input device that receives user operations (for example, see Patent Literature (PTL) 1).

### CITATION LIST

### Patent Literature

PTL 1: Japanese Unexamined Patent Application Publication No. 2017-218094

### SUMMARY

### Technical Problem

However, the above-described conventional shifting device can be improved upon.

In view of the above, the present disclosure provides an input device capable of improving upon the above related art.

### Solution to Problem

An input device according to one aspect of the present disclosure includes: an operation component that tilts in a first direction in response to a user operation; an expansion component that tilts in the first direction relative to the operation component, in conjunction with tilting of the operation component; a detected element to be detected that is supported by the expansion component; a detector that is disposed to face the detected element, and detects a tilting movement made by the operation component; a detent pin that provides a clicking sensation for an operation to tilt the operation component, and is supported by the expansion component in a retractable manner; and an energizing component that energizes the detent pin toward a detent surface to press a tip of the detent pin against the detent surface. With respect to a tilt amount of the operation component, the expansion component increases a movement amount of the detected element and a movement amount of the tip of the detent pin in a direction parallel to the detent surface.

### Advantageous Effects

An input device according to one aspect of the present disclosure can improve upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a perspective view of an input device according to an embodiment.

FIG. 2 is an exploded perspective view of the input device according to the embodiment.

FIG. 3 is a perspective view of an internal mechanism of the input device according to the embodiment, illustrated without a cover and a sensor board.

FIG. 4 is a cross sectional view of the input device according to the embodiment, taken along line IV-IV shown in FIG. 1.

FIG. 5 is a side view of the internal mechanism of the input device according to the embodiment, illustrated without the cover and a board.

FIG. 6 is a cross sectional view of the input device according to the embodiment, taken along line VI-VI shown in FIG. 1.

FIG. 7 is a side view of the internal mechanism of the input device according to the embodiment, illustrating the input device in a state in which the operation component is tilted from the home position to the drive position.

FIG. 8 is a cross sectional view of the input device according to the embodiment, illustrating the input device in a state in which the operation component is tilted from the home position to the drive position.

FIG. 9 is a side view of the internal mechanism of the input device according to the embodiment, illustrating the input device in a state in which the operation component is tilted from the home position to the reverse position.

FIG. 10 is a cross sectional view of the input device according to the embodiment, illustrating the input device in a state in which the operation component is tilted from the home position to the reverse position.

### DESCRIPTION OF EMBODIMENT

### Underlying Knowledge Forming Basis of the Present Disclosure

The inventors of the present disclosure have found that the technique presented in the “Background” section causes the following problems.

There are shifting devices that include a shift lever that tilts in a predetermined direction in response to a user operation and a detent mechanism that provides a clicking sensation for an operation to tilt the shift lever (a feeling of having operated the shift lever).

In recent years, a tilt amount (the maximum tilt angle) of a shift lever tends to decrease along with a demand for downsizing these shifting devices. For this reason, conventional detent mechanisms can be improved upon in providing a clicking sensation for an operation to tilt a shift lever.

An input device according to one aspect of the present disclosure includes: an operation component that tilts in a first direction in response to a user operation; an expansion component that tilts in the first direction relative to the operation component, in conjunction with tilting of the operation component; a detected element to be detected that is supported by the expansion component; a detector that is disposed to face the detected element, and detects a tilting movement made by the operation component; a detent pin that provides a clicking sensation for an operation to tilt the operation component, and is supported by the expansion component in a retractable manner; and an energizing component that energizes the detent pin toward a detent surface to press a tip of the detent pin against the detent surface. With respect to a tilt amount of the operation component, the expansion component increases a movement amount of the detected element and a movement amount of the tip of the detent pin in a direction parallel to the detent surface.

According to the present aspect, the expansion component tilts in the first direction in conjunction with tilting of the operation component to increase, with respect to a tilt amount of the operation component, a movement amount of the tip of the detent pin in a direction parallel to the detent surface. With this, even if the tilt amount of the operation component is reduced, the movement amount of the tip of the detent pin in the direction parallel to the detent surface can be sufficiently secured, and thus a clicking sensation for an operation to tilt the operation component can be easily provided.

For example, the input device may be configured as follows. The expansion component is engaged with the operation component in a second direction to tilt in conjunction with tilting of the operation component. The second direction is substantially orthogonal to the first direction and is a lateral direction of the operation component. The detected element and the detector are disposed to face each other in the second direction. The expansion component includes a hole that extends in a predetermined direction. The detent pin and the energizing component are disposed in the hole in the expansion component.

According to the present aspect, the detent pin and the energizing component can be compactly accommodated in the hole in the expansion component.

For example, the input device may be configured as follows. The input device further includes a housing that includes a first bearing portion and a second bearing portion. The operation component includes a shaft and a knob disposed at one end portion of the shaft and operated by the user. The shaft includes a first shaft portion that is supported by the first bearing portion of the housing and serves as the central axis about which the operation component tilts, and a first engagement portion disposed closer to the knob than the first shaft portion is. The expansion component includes a second shaft portion that is supported by the second bearing portion of the housing and serves as the central axis about which the expansion component tilts, and a second engagement portion disposed closer to the knob than the second shaft portion is and engaged with the first engagement portion of the shaft. The detected element and the detent pin are disposed, relative to the second shaft portion, on a side opposite to a side on which the knob is disposed. A length between the second shaft portion of the expansion component and the detected element is greater than a length between the second engagement portion in the expansion component and the second shaft portion. A length between the second shaft portion of the expansion component and the tip of the detent pin is greater than the length between the second engagement portion in the expansion component and the second shaft portion.

According to the present aspect, a comparatively simple configuration can increase, with respect to a tilt amount of the operation component, a movement amount of the detected element and a movement amount of the tip of the detent pin in the direction parallel to the detent surface.

For example, the input device may be configured as follows. The input device further includes a detent component including the detent surface. In a state in which the operation component is not tilted, a longitudinal direction of the hole in the expansion component is a third direction that is substantially orthogonal to both the first direction and the second direction. When viewed from the second direction, the detent surface is formed to have a height in the third direction which gradually increases in the first direction. The energizing component is disposed in the hole in the expansion component to energize the detent pin in at least the third direction.

According to the present aspect, the energizing component is disposed in the hole in the expansion component so as to energize the detent pin in at least the third direction. With this, the expansion component is caused to, by a reaction force, energize in at least the third direction toward the knob side, unsteadiness of the detected element supported by the expansion component can be inhibited. As a result, the accuracy of detection by the detector can be increased.

For example, the input device may be configured such that the first engagement portion of the shaft is a protruding portion that protrudes in the second direction, and the second engagement portion in the expansion component is recessed in shape when viewed from the second direction, and is a recessed portion into which the protruding portion is inserted.

According to the present aspect, the expansion component can be readily engaged with the operation component in the second direction such that the expansion component tilts in conjunction with tilting of the operation component.

For example, the detent component may include an insertion through-hole through which the first shaft portion of the shaft is inserted. The detent component may be configured to be supported by the first bearing portion of the housing, together with the first shaft portion of the shaft.

According to the present aspect, the detent component can be supported by the first bearing portion of the housing, together with the first shaft portion of the shaft.

Hereinafter, embodiments will be described in detail with reference to the drawings.

Note that the embodiments below each describe a general or specific example. The numerical values, shapes, materials, elements, the arrangement and connection of the elements, steps, orders of the steps, etc. presented in the embodiment below are mere examples, and are not intended to limit the present disclosure. Furthermore, among the elements in the embodiments below, those not recited in any one of the independent claims representing the most generic concepts will be described as optional elements.

### Embodiment

### [1. Configuration of Input Device]

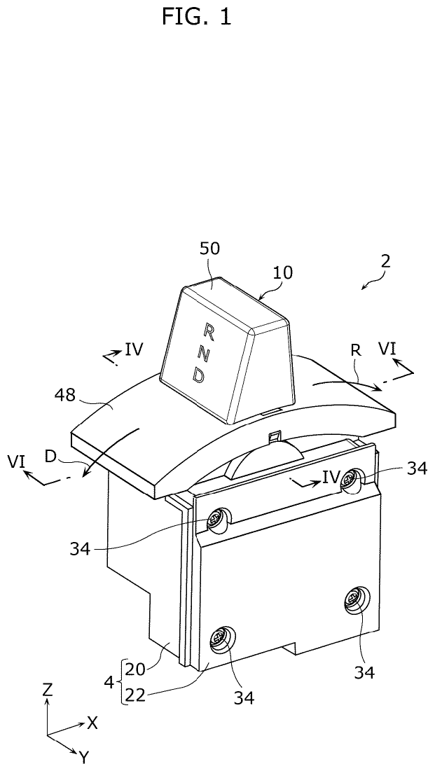

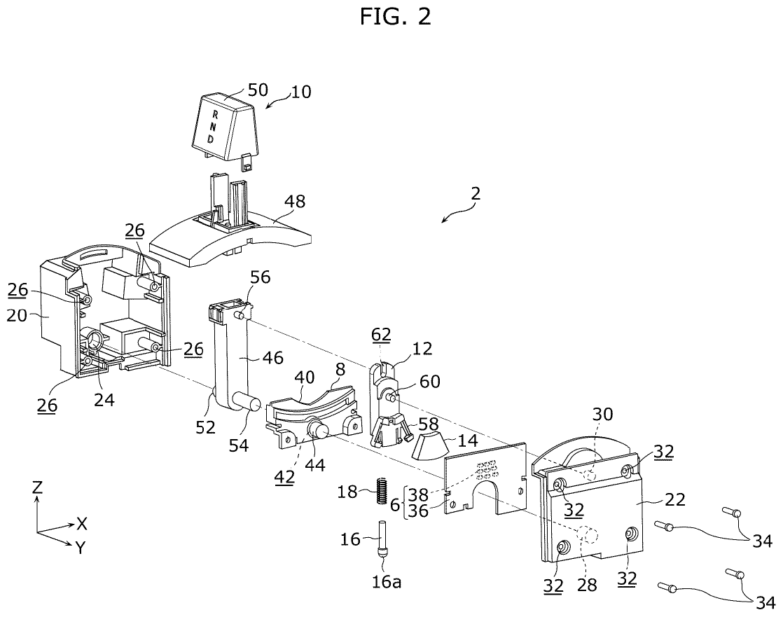

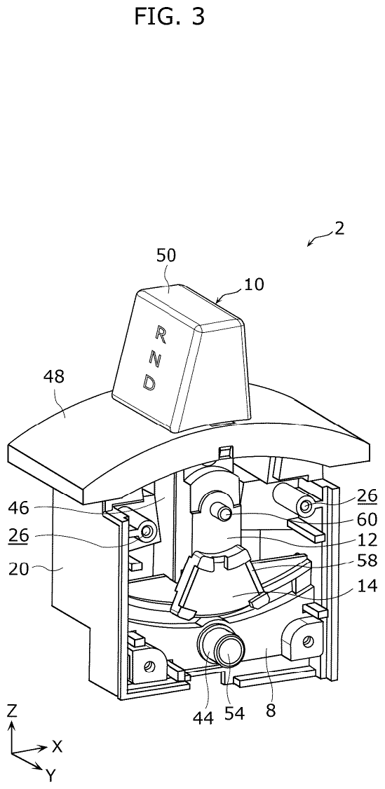

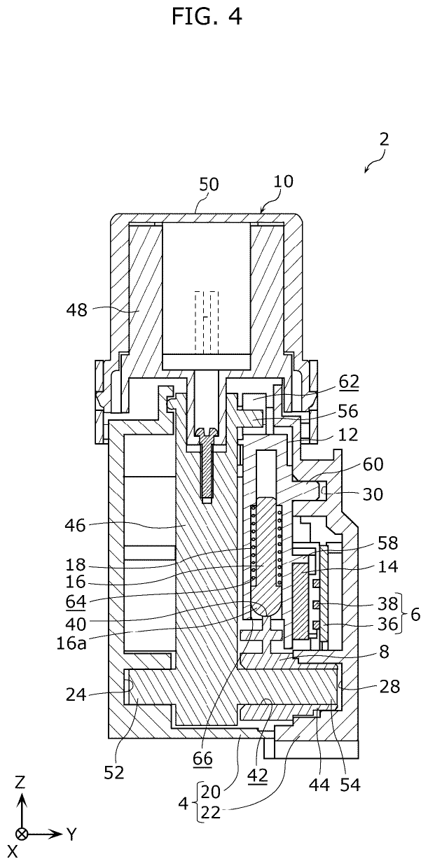

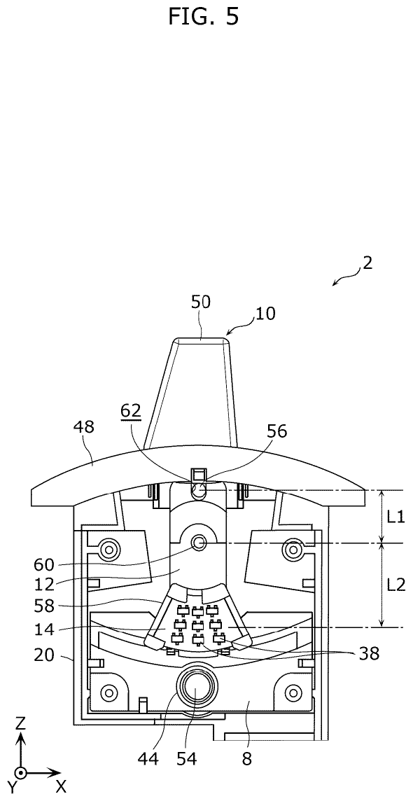

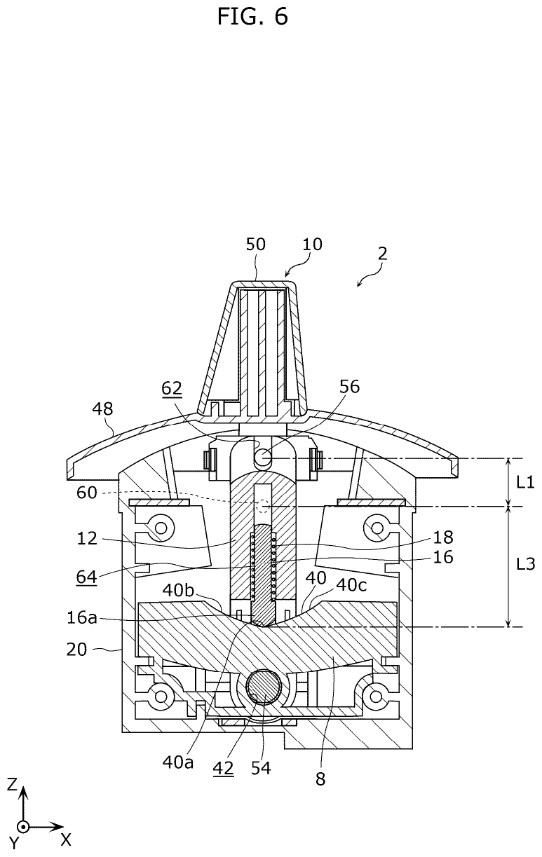

First, a configuration of input device 2 according to the embodiment will be described with reference to FIG. 1 through FIG. 6. FIG. 1 is a perspective view of input device 2 according to the embodiment. FIG. 2 is an exploded perspective view of input device 2 according to the embodiment. FIG. 3 is a perspective view of an internal mechanism of input device 2 according to the embodiment, illustrated without cover 22 and sensor board 6. FIG. 4 is a cross sectional view of input device 2 according to the embodiment, taken along line IV-IV shown in FIG. 1. FIG. 5 is a side view of the internal mechanism of input device 2 according to the embodiment, illustrated without cover 22 and board 36. FIG. 6 is a cross sectional view of input device 2 according to the embodiment, taken along line VI-VI shown in FIG. 1.

Note that in FIG. 1 through FIG. 6, the X axis represents the forward-backward direction (one example of a first direction) of input device 2, the Y axis represents the left-right direction (one example of a second direction) of input device 2, and the Z axis represents the up-down direction (one example of a third direction) of input device 2. In addition, the positive side of the X axis represents the side far from the viewer, the negative side of the X axis represents the side closer to the viewer, the positive side of the Y axis represents the right side, the negative side of the Y axis represents the left side, the positive side of the Z axis represents an upward direction, and the negative side of the Z axis represents a downward direction.

In the present embodiment, input device 2 is a shifting device provided in, for example, the center console of a vehicle. Input device 2 switches transmission modes of the vehicle between the drive mode and reverse mode in response to a user (driver) operation. The vehicle is an automobile, such as a typical passenger car, a bus, or a truck.

As illustrated in FIG. 1 and FIG. 2, input device 2 includes housing 4, sensor board 6 (one example of a detector), detent component 8, operation component 10, expansion component 12, magnet 14 (one example of a detected element to be detected), detent pin 16, and energizing component 18.

As illustrated in FIG. 1, housing 4 includes case 20 and cover 22 joined together. Housing 4 is embedded inside the center console of the vehicle, for example. As illustrated in FIG. 2, first bearing portion 24 recessed in shape is formed in the vicinity of the bottom end portion of an internal surface (the surface facing cover 22) of case 20. Four screw holes 26 are also formed in respective four corners of the internal surface of case 20. First bearing portion 28 recessed in shape is formed in the vicinity of the bottom end portion of an internal surface (the surface facing case 20) of cover 22. Second bearing portion 30 recessed in shape is formed in the vicinity of the upper end portion of the internal surface of cover 22. Four through holes 32 are also formed in respective four corners of cover 22. Four screws 34 are screwed, through four through holes 32 in cover 22, into respective four screw holes 26 to securely join case 20 and cover 22 together. Housing 4 including case 20 and cover 22 joined together as described above is hollow inside, and the upper end portion of housing 4 is opened.

As illustrated in FIG. 4, sensor board 6 is disposed facing magnet 14 inside housing 4. As illustrated in FIG. 2 and FIG. 4, sensor board 6 includes board 36 and a plurality of hole elements 38. Board 36 is a printed circuit board, and is attached to the internal surface of cover 22. The plurality of hole elements 38 are mounted on one surface (the surface facing magnet 14) of board 36, and detect a magnetic field produced from magnet 14. Although not illustrated, besides the plurality of hole elements 38, a plurality of electronic components are mounted on the one surface of board 36. As will be described later, when operation component 10 is tilted, the magnet field of magnet 14 which is to be detected by the plurality of hole elements 38 changes due to a change in a relative positional relationship between magnet 14 and the plurality of hole elements 38. Sensor board 6 generates an electrical signal corresponding to the magnetic field of magnet 14 which is detected by the plurality of hole elements 38, and detects, based on the generated electrical signal, a tilting movement (e.g., a tilting direction) made by operation component 10.

As illustrated in FIG. 3 and FIG. 5, detent component 8 is disposed, inside housing 4, below expansion component 12. As illustrated in FIG. 2 and FIG. 6, detent surface 40 defined by a substantially V-shaped notch when viewed from the Y axis direction is formed in the upper end portion of detent component 8. Detent surface 40 includes bottom portion 40a, first inclined surface 40b, and second inclined surface 40c. When viewed from the Y axis direction, first inclined surface 40b is formed such that the height in the Z axis direction gradually increases from bottom portion 40a toward the negative side of the X axis. When viewed from the Y axis direction, second inclined surface 40c is formed such that the height in the Z axis direction gradually increases from bottom portion 40a toward the positive side of the X axis. In addition, as illustrated in FIG. 2 and FIG. 4, detent component 8 includes insertion through-hole 42 and support portion 44. Support portion 44 communicates with insertion through-hole 42. Support portion 44 protrudes, in the shape of a tube, from the outer circumference of insertion through-hole 42 toward the positive side of the Y axis, and is supported by first bearing portion 28 of cover 22.

As illustrated in FIG. 2, operation component 10 includes shaft 46, knob cover 48, and knob 50. Shaft 46 is long in shape in the up-down direction, and is disposed inside housing 4. First shaft portion 52 that protrudes toward the negative side of the Y axis is formed at the bottom end portion of the left-side surface (the surface facing case 20) of shaft 46. As illustrated in FIG. 4, first shaft portion 52 is rotatably supported by first bearing portion 24 of case 20. First shaft portion 54 that protrudes toward the positive side of the Y axis is formed at the bottom end portion of the right-side surface (the surface facing cover 22) of shaft 46. As illustrated in FIG. 4, first shaft portion 54 is inserted through insertion through-hole 42 and support portion 44 in detent component 8, and is rotatably supported by first bearing portion 28 of cover 22 via support portion 44. With this, detent component 8 is supported by first bearing portion 28 of cover 22, together with first shaft portion 54 of shaft 46. Detent component 8 is also secured to housing 4 with screws 34.

Protruding portion 56 (one example of a first engagement portion) that protrudes toward the positive side of the Y axis is formed at the upper end portion of the right-side surface of shaft 46. Protruding portion 56 disposed closer to knob 50 than first shaft portion 54 is.

Knob cover 48 is supported by the upper end portion of shaft 46, and is disposed outside housing 4 so as to cover the opened upper end portion of housing 4. Knob 50 is supported by the upper end portion of knob cover 48, and rises from knob cover 48 toward the upward direction. Knob cover 48 and knob 50 are exposed outside the center console of the vehicle, for example.

A user sliding knob 50 toward themselves by gripping knob 50 with their hand causes operation component 10 to tilt, about first shaft portion 54 that serves as the central axis, in the direction indicated by the arrow D in FIG. 1 parallel to the X axis direction. In this case, the transmission mode of the vehicle is switched to the drive mode. Conversely, the user sliding knob 50 away from themselves by gripping knob 50 with their hand causes operation component 10 to tilt, about first shaft portion 54 that serves as the central axis, in the direction indicated by the arrow R in FIG. 1 parallel to the X axis direction. In this case, the transmission mode of the vehicle is switched to the reverse mode.

As illustrated in FIG. 3 and FIG. 4, expansion component 12 is disposed in a lateral direction of operation component 10 (disposed farther on the positive side of the Y axis than operation component 10 is) inside housing 4. Expansion component 12 is long in shape in the up-down direction. Holder 58 is formed at the bottom end portion of the right-side surface (the surface facing cover 22) of expansion component 12. Second shaft portion 60 that protrudes toward the positive side of the Y axis is formed in the vicinity of the upper end portion of the right-side surface of expansion component 12. As illustrated in FIG. 4, second shaft portion 60 is rotatably supported by second bearing portion 30 of cover 22. Recessed portion 62 (one example of a second engagement portion) is formed in the upper end portion of expansion component 12. Recessed portion 62 is recessed in shape (U-shaped) when viewed from the Y axis direction, and is closer to knob 50 than second shaft portion 60 is. Protruding portion 56 of shaft 46 is inserted into recessed portion 62 of expansion component 12, and thus protruding portion 56 of shaft 46 is engaged with recessed portion 62 of expansion component 12. With this, expansion component 12 is engaged with operation component 10 in the lateral direction of operation component 10 so as to tilt in conjunction with tilting of operation component 10.

Moreover, as illustrated in FIG. 4, expansion component 12 includes, inside expansion component 12, hole 64 that extends in the longitudinal direction (one example of a predetermined direction) of expansion component 12. Opening 66 communicating with hole 64 is formed in the bottom end portion of expansion component 12. In a state in which operation component 10 is not tilted (the state shown in FIG. 1 through FIG. 6), the longitudinal direction of hole 64 is substantially parallel to the up-down direction.

In conjunction with tilting of operation component 10, expansion component 12 tilts, about second shaft portion 60 that serves as the central axis, in the X axis direction relative to operation component 10. With this, expansion component 12 increases, with respect to a tilt amount of operation component 10, the movement amount of magnet 14 as well as the movement amount of tip 16a of detent pin 16 in the direction parallel to detent surface 40.

As illustrated in FIG. 3 and FIG. 4, magnet 14 is supported by holder 58 of expansion component 12, and is disposed facing sensor board 6 in the Y axis direction. Magnet 14 is disposed, relative to second shaft portion 60, on the side opposite to a side on which knob 50 is disposed. As illustrated in FIG. 5, length L2 between second shaft portion 60 of expansion component 12 and magnet 14 is greater than length L1 between recessed portion 62 in expansion component 12 and second shaft portion 60.

Detent pin 16 is long in shape in the up-down direction. As illustrated in FIG. 4 and FIG. 6, detent pin 16 is disposed in hole 64 in expansion component 12, and is retractable in the longitudinal direction of hole 64. Detent pin 16 is disposed, relative to second shaft portion 60, on the side opposite to a side on which knob 50 is disposed. Tip 16a (the lower end portion) of detent pin 16 is in contact with detent surface 40 of detent component 8 through opening 66 in expansion component 12.

As illustrated in FIG. 6, length L3 between second shaft portion 60 of expansion component 12 and tip 16a of detent pin 16 is greater than length L1 between recessed portion 62 in expansion component 12 and second shaft portion 60. In the present embodiment, as illustrated in FIG. 4, detent pin 16 is disposed on the rear side of magnet 14 when viewed from the Y axis direction, but the relative positional relationship between detent pin 16 and magnet 14 is not limited thereto.

Energizing component 18 is, for example, a coiled spring. As illustrated in FIG. 4 and FIG. 6, energizing component 18 is disposed in hole 64 in expansion component 12 so as to surround the outer surface of detent pin 16 in a manner that allows energizing component 18 to expand and to be compressed. Energizing component 18 energizes detent pin 16 toward detent surface 40 so that tip 16a of detent pin 16 is pressed against detent surface 40.

Note that since energizing component 18 energizes detent pin 16 in at least the up-down direction, a reaction force of the energization energizes expansion component 12 in at least the third direction toward the knob 50 side. With this, unsteadiness of magnet 14 that is supported by expansion component 12 can be inhibited, and thus the accuracy of detection by sensor board 6 can be increased.

### [2. Operation and Advantageous Effect of Input Device]

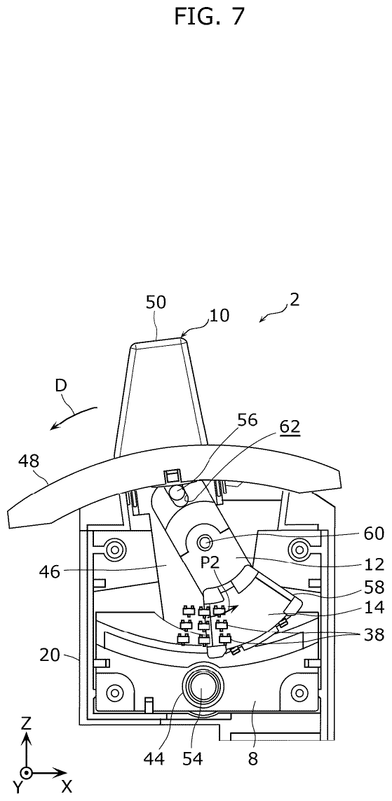

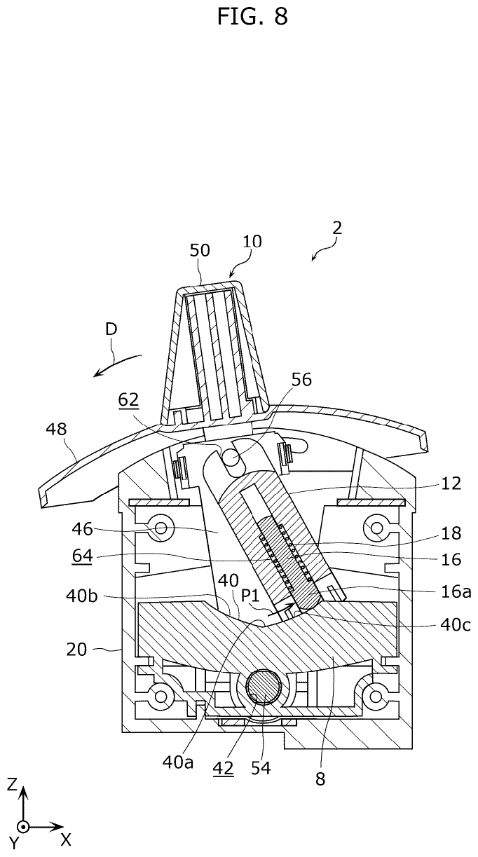

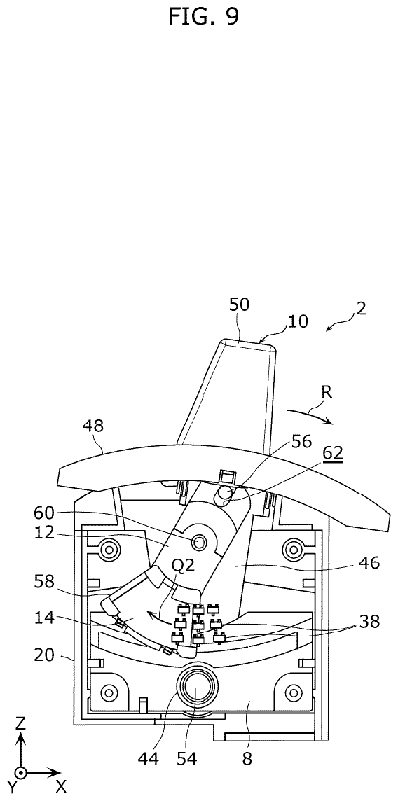

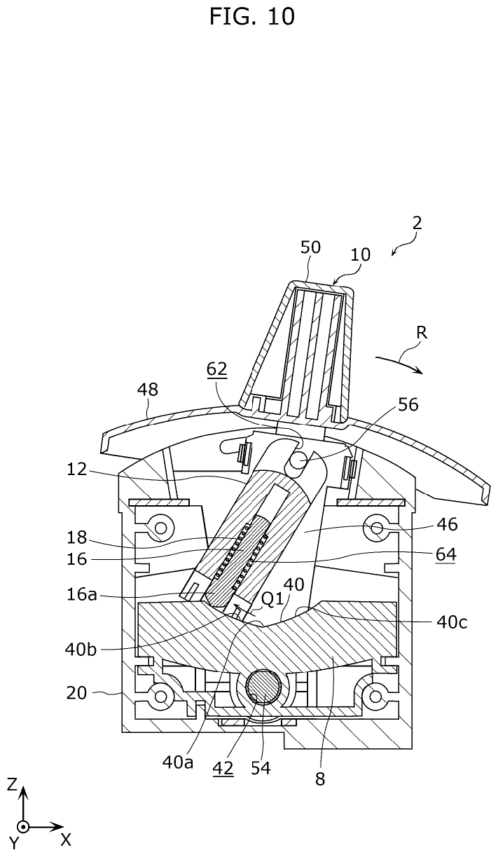

Next, operation performed by input device 2 according to the embodiment will be described with reference to FIG. 5 through FIG. 10. FIG. 7 is a side view of the internal mechanism of input device 2 according to the embodiment, illustrating input device 2 in a state in which operation component 10 is tilted from the home position to the drive position. FIG. 8 is a cross sectional view of input device 2 according to the embodiment, illustrating input device 2 in a state in which operation component 10 is tilted from the home position to the drive position. FIG. 9 is a side view of the internal mechanism of input device 2 according to the embodiment, illustrating input device 2 in a state in which operation component 10 is tilted from the home position to the reverse position. FIG. 10 is a cross sectional view of input device 2 according to the embodiment, illustrating input device 2 in a state in which operation component 10 is tilted from the home position to the reverse position.

Note that FIG. 7 and FIG. 9 omit illustrations of cover 22 and board 36 for convenience of describing the operation of the input device. In addition, FIG. 8 and FIG. 10 each are a cross sectional view of input device 2 according to the embodiment, taken along a cutting-plane line corresponding to cutting plane line VI-VI shown in FIG. 1.

As illustrated in FIG. 5 and FIG. 6, operation component 10 is held in the home position in a state in which a user does not operate knob 50 of operation component 10. In the home position, both operation component 10 and expansion component 12 are held in an upright position in the up-down direction. In addition, tip 16a of detent pin 16 is in contact with bottom portion 40a of detent surface 40 of detent component 8.

As illustrated in FIG. 7 and FIG. 8, when a user grips knob 50 with their hand and slides knob 50 toward themselves, operation component 10 tilts, about first shaft portion 54 that serves as the central axis, from the home position to the drive position in a direction indicated by the arrow D shown in FIG. 7 and FIG. 8. In this drive position, both operation component 10 and expansion component 12 are in the position tilted toward the user relative to the up-down direction. Since protruding portion 56 of shaft 46 is engaged with recessed portion 62 in expansion component 12 in this position, expansion component 12 tilts, about second shaft portion 60 that serves as the central axis, in the X axis direction relative to operation component 10 in conjunction with tilting of operation component 10.

Along with tilting of expansion component 12, tip 16a of detent pin 16 moves, in a direction indicated by arrow P1 shown in FIG. 8, from bottom portion 40a of detent surface 40 to the upper end portion of second inclined surface 40c while sliding along second inclined surface 40c. A change in a load on energizing component 18 resulting from energizing component 18 being compressed due the movement made by detent pin 16 provides a clicking sensation for an operation to tilt operation component 10 (a feeling of having operated operation component 10).

As has been described above, since length L3 between second shaft portion 60 of expansion component 12 and tip 16a of detent pin 16 is greater than length L1 between recessed portion 62 in expansion component 12 and second shaft portion 60, the movement amount of tip 16a of detent pin 16 in a direction parallel to detent surface 40 (second inclined surface 40c) is greater than the movement amount of the upper end portion of expansion component 12. In other words, expansion component 12 increases, with respect to a tilt amount of operation component 10, a movement amount of tip 16a of detent pin 16 in the direction parallel to detent surface 40 (second inclined surface 40c). With this, even if the tilt amount of operation component 10 is reduced, the movement amount of tip 16a of detent pin 16 in the direction parallel to detent surface 40 (second inclined surface 40c) can be sufficiently secured, and thus a clicking sensation for an operation to tilt operation component 10 can be easily provided.

In addition, along with tilting of expansion component 12, magnet 14 moves in the direction indicated by arrow P2 shown in FIG. 7. As has been described above, since length L2 between second shaft portion 60 of expansion component 12 and magnet 14 is greater than length L1 between recessed portion 62 in expansion component 12 and second shaft portion 60, the movement amount of magnet 14 is greater than the movement amount of the upper end portion of expansion component 12. In other words, expansion component 12 increases, with respect to a tilt amount of operation component 10, a movement amount of magnet 14. With this, even if a tilt amount of operation component 10 is reduced, the relative positional relationship between magnet 14 and the plurality of hole elements 38 greatly changes when viewed from the Y axis direction as illustrated in FIG. 5 and FIG. 7. Accordingly, the accuracy of detection by sensor board 6 can be increased.

Note that, as illustrated in FIG. 7, when operation component 10 tilts from the home position to the drive position and a user takes their hand off knob 50, an elastic restoring force exerted by energizing component 18 causes operation component 10 to return from the drive position to the home position.

As illustrated in FIG. 9 and FIG. 10, when a user grips knob 50 with their hand and slides knob 50 away from themselves, operation component 10 tilts, about first shaft portion 54 that serves as the central axis, from the home position to the reverse position in the direction indicated by the arrow R shown in FIG. 9 and FIG. 10. In this reverse position, both operation component 10 and expansion component 12 are in the position tilted away from the user relative to the up-down direction. Since protruding portion 56 of shaft 46 is engaged with recessed portion 62 in expansion component 12 in this position, expansion component 12 tilts, about second shaft portion 60 that serves as the central axis, in the X axis direction relative to operation component 10 in conjunction with tilting of operation component 10.

Along with tilting of expansion component 12, tip 16a of detent pin 16 moves, in a direction indicated by arrow Q1 shown in FIG. 10, from bottom portion 40a of detent surface 40 to the upper end portion of first inclined surface 40b while sliding along first inclined surface 40b. A change in a load on energizing component 18 that results from energizing component 18 being compressed due the movement made by detent pin 16 provides a clicking sensation for an operation to tilt operation component 10.

As has been described above, since length L3 between second shaft portion 60 of expansion component 12 and tip 16a of detent pin 16 is greater than length L1 between recessed portion 62 in expansion component 12 and second shaft portion 60, the movement amount of tip 16a of detent pin 16 in a direction parallel to detent surface 40 (first inclined surface 40b) is greater than the movement amount of the upper end portion of expansion component 12. In other words, expansion component 12 increases, with respect to a tilt amount of operation component 10, the movement amount of tip 16a of detent pin 16 in the direction parallel to detent surface 40 (first inclined surface 40b). With this, even if the tilt amount of operation component 10 is reduced, the movement amount of tip 16a of detent pin 16 in the direction parallel to detent surface 40 (first inclined surface 40b) can be sufficiently secured, and thus a clicking sensation for an operation to tilt operation component 10 can be easily provided.

In addition, along with tilting of expansion component 12, magnet 14 moves in the direction indicated by arrow Q2 shown in FIG. 9. As has been described above, since length L2 between second shaft portion 60 of expansion component 12 and magnet 14 is greater than length L1 between recessed portion 62 in expansion component 12 and second shaft portion 60, the movement amount of magnet 14 is greater than the movement amount of the upper end portion of expansion component 12. In other words, expansion component 12 increases, with respect to a tilt amount of operation component 10, a movement amount of magnet 14. With this, even if a tilt amount of operation component 10 is reduced, the relative positional relationship between magnet 14 and the plurality of hole elements 38 greatly changes when viewed from the Y axis direction as illustrated in FIG. 5 and FIG. 9. Accordingly, the accuracy of detection by sensor board 6 can be increased.

Note that, as illustrated in FIG. 9, when operation component 10 tilts from the home position to the reverse position and a user takes their hand off knob 50, an elastic restoring force exerted by energizing component 18 causes operation component 10 to return from the reverse position to the home position.

### Other Variations

Hereinbefore, the input device according to one or more aspects has been described based on the above-described embodiment, but the present disclosure is not limited thereto. The present disclosure may encompass embodiments to which various modifications that may be conceived by those skilled in the art are made and embodiments achieved by combining elements in different embodiments, as long as resultant embodiments do not depart from the spirit of the present disclosure.

Input device 2 has been applied to a shifting device for a vehicle in the above-described embodiment, but input device 2 is non-limiting; input device 2 may be applied to operation levers and the like of, for example, consumer appliances or industrial appliances.

While various embodiments have been described herein above, it is to be appreciated that various changes in form and detail may be made without departing from the spirit and scope of the present disclosure as presently or hereafter claimed.

### Further Information about Technical Background to this Application

The disclosures of the following patent applications including specification, drawings, and claims are incorporated herein by reference in their entirety: Japanese Patent Application No. 2022-007818 filed on Jan. 21, 2022 and PCT International Application No. PCT/JP2022/043089 filed on Nov. 22, 2022.

### Industrial Applicability

The input device according to the present disclosure is applicable to, for example, shifting devices and the like for vehicles.

1. An input device comprising:
an operation component that tilts in a first direction in response to a user operation;
an expansion component that tilts in the first direction relative to the operation component, in conjunction with tilting of the operation component;
a detected element to be detected that is supported by the expansion component;
a detector that is disposed to face the detected element, and detects a tilting movement made by the operation component;
a detent pin that provides a clicking sensation for an operation to tilt the operation component, and is supported by the expansion component in a retractable manner; and
an energizing component that energizes the detent pin toward a detent surface to press a tip of the detent pin against the detent surface, wherein
with respect to a tilt amount of the operation component, the expansion component increases a movement amount of the detected element and a movement amount of the tip of the detent pin in a direction parallel to the detent surface.

2. The input device according to claim 1, wherein
the expansion component is engaged with the operation component in a second direction to tilt in conjunction with tilting of the operation component, the second direction being substantially orthogonal to the first direction and being a lateral direction of the operation component,
the detected element and the detector are disposed to face each other in the second direction,
the expansion component includes a hole that extends in a predetermined direction, and
the detent pin and the energizing component are disposed in the hole in the expansion component.

3. The input device according to claim 2, wherein
the input device further comprises a housing that includes
a first bearing portion and a second bearing portion, the operation component includes:
a shaft; and
a knob disposed at one end portion of the shaft and operated by the user,
the shaft includes:
a first shaft portion that is supported by the first bearing portion of the housing, and serves as a central axis about which the operation component tilts; and
a first engagement portion disposed closer to the knob than the first shaft portion is,
the expansion component includes:
a second shaft portion that is supported by the second bearing portion of the housing, and serves as a central axis about which the expansion component tilts; and
a second engagement portion disposed closer to the knob than the second shaft portion is, and engaged with the first engagement portion of the shaft,
the detected element and the detent pin are disposed, relative to the second shaft portion, on a side opposite to a side on which the knob is disposed,
a length between the second shaft portion of the expansion component and the detected element is greater than
a length between the second engagement portion in the expansion component and the second shaft portion, and
a length between the second shaft portion of the expansion component and the tip of the detent pin is greater than the length between the second engagement portion in the expansion component and the second shaft portion.

4. The input device according to claim 3, wherein
the input device further comprises a detent component including the detent surface,
in a state in which the operation component is not tilted, a longitudinal direction of the hole in the expansion component is a third direction that is substantially orthogonal to both the first direction and the second direction,
when viewed from the second direction, the detent surface is formed to have a height in the third direction which gradually increases in the first direction, and
the energizing component is disposed in the hole in the expansion component to energize the detent pin in at least the third direction.

5. The input device according to claim 4, wherein
the first engagement portion of the shaft is a protruding portion that protrudes in the second direction, and
the second engagement portion in the expansion component is recessed in shape when viewed from the second direction, and is a recessed portion into which the protruding portion is inserted.

6. The input device according to claim 4, wherein
the detent component includes an insertion through-hole through which the first shaft portion of the shaft is inserted, and
the detent component is supported by the first bearing portion of the housing, together with the first shaft portion of the shaft.
